(19) United States
(12) Patent Application Publication
(10) Pub. No.: US 2018/0209702 A1
(43) Pub. Date: Jul. 26, 2018

(54) COMPRESSOR DRIVE SYSTEM AND METHOD

(71) Applicant: Gloria Lee, Avon, OH (US)

(72) Inventor: Gloria Lee, Avon, OH (US)

(21) Appl. No.: 15/818,703

(22) Filed: Nov. 20, 2017

Related U.S. Application Data
(60) Provisional application No. 62/449,163, filed on Jan. 23, 2017.

(51) Int. Cl. F25B 31/02; B23P 15/26

(52) U.S. Cl. CPC F25B 31/026; F25B 2400/07; B23P 15/26

(57) ABSTRACT

A compressor drive system includes a power supply fixed to the vehicle, an electric motor electrically coupled to the power supply and mechanically coupled to the compressor for driving the compressor, and a controller communicably coupled to the vehicle for operating the electric motor when the compressor drive is turned on. The compressor drive system may be useful for providing an alternate source for powering the compressor of a vehicle air-conditioner system that does not reduce vehicle shaft horsepower nor directly mechanically connect to the vehicle engine power take off.

### CROSS-REFERENCE TO RELATED APPLICATION(S)

The present application is related to and claims priority to U.S. Provisional Patent Application No. 62/449,163 filed Jan. 23, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of air-conditioning systems of existing art, and more specifically relates to a vehicle air-conditioner compressor drive system.

### RELATED ART

An air conditioning apparatus for a personal motor vehicle generally includes a compressor that is driven by a power take-off from the engine. A condenser is positioned in line with the engine radiator. Both the compressor and condenser are cooled by a common fan that is also driven by a power take-off from the engine.

Commonly, the A/C Compressor used in vehicles today has a pulley that runs off of the engine shaft power, and includes an electro magnet clutch to engage the compressor and bands/belts that turn the compressor. This configuration causes undue strain on the engine and a loss of shaft power, which reduces the drive power of the engine. This also results in greater fuel consumption and slower speeds. In addition, costs to maintain the A/C compressor system can be high, and the lifespan tends to be short. An efficient alternative is needed.

U.S. Pat. No. 5,714,806 to Naomi Goto relates to an air-conditioning system for vehicle. The described air-conditioning system for vehicle includes a drive circuit for driving an electric compressor is connected with a DC power source. Arranged between the DC power source and the drive circuit is a switch which, when turned on, supplies an electric current there through the drive circuit. Also a capacitor is connected parallel to a drive circuit and a switch is connected parallel to a resistance. When starting, the control circuit activates the drive circuit to drive the compressor. Subsequently, the control circuit turns the switch on so that the current is supplied from the DC power source to the drive circuit.

### SUMMARY OF THE INVENTION

In view of the foregoing disadvantages inherent in the known air-conditioning systems art, the present disclosure provides a novel compressor drive system. The general purpose of the present disclosure, which will be described subsequently in greater detail, is to provide a shaft decoupled compressor drive system.

A compressor drive system is disclosed herein. The compressor drive system includes a power supply fixed to the vehicle, an electric motor electrically coupled to the power supply and mechanically coupled to the compressor, and a controller communicably coupled to the vehicle. The electric motor is configured to drive the compressor, and the controller is configured to operate the electric motor when the compressor drive system is turned on.

According to another embodiment, a kit for retrofitting an air-conditioner in a vehicle is also disclosed herein. The kit for retrofitting an air-conditioner in a vehicle includes a power supply configured to affix to the vehicle, a compressor adapter configured to mount to the compressor, an electric motor configured to electrically couple to the power supply and to mechanically couple to the electric motor mount of the compressor adapter, and a controller communicably coupled to the vehicle.

According to yet another embodiment, a method of operating an air-conditioner of a vehicle is also disclosed herein. The method of operating an air-conditioner of a vehicle includes installing a compressor drive system in the vehicle, the compressor drive system including a power supply fixed to the vehicle, an electric motor electrically coupled to the power supply and mechanically coupled to the compressor, the electric motor configured to drive the compressor, and a controller communicably coupled to the vehicle, the controller configured to operate the electric motor when the compressor drive system is turned on. The method further includes activating the air compressor of the vehicle while the engine is in an off state, and driving the compressor of the air conditioner via the compressor drive system.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a compressor drive system, constructed and operative according to the teachings of the present disclosure.

FIG. 1 is a perspective view of the compressor drive system during an ‘in-use’ condition, according to an embodiment of the disclosure.

FIG. 2 is a perspective view of the components of the compressor drive system of FIG. 1 in isolation, according to an embodiment of the present disclosure.

FIG. 3 is an assembly view of the compressor drive system of FIG. 1, according to an embodiment of the present disclosure.

FIG. 4 is another assembly view of the compressor drive system of FIG. 1, according to an embodiment of the present disclosure.

FIG. 5 is a flow diagram illustrating a method of operating an air-conditioner of a vehicle, according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to air-conditioning systems, and more particularly to a compressor drive system as used to improve the efficiency of a vehicle air-conditioning system while reducing horsepower loss and increasing gas mileage.

Generally, the present disclosure replaces the conventional vehicle air conditioning motor with an electric motor to reduce strain on automotive engines, while providing improved gas mileage, for example during A/C idle while driving. It may reduce oil and gasoline consumption, increase miles per gallon, and allow for more available horsepower for the drive train. Also, this may enable the air conditioning to stay running without using additional fuel to idle the engine and by including a lithium ion battery in the assembly. The compressor drive system may be modular and further eliminate replacement costs for belts, pulleys, clutches, bands, and compressor adjustments. The present disclosure may further provide a conversion kit to modify conventional compressors found on cars, trucks, RVs, buses, construction equipment, and more.

The included DC power source may be configured to feed energy to an independent electric motor that is responsible for driving the AC system compressor. As a result, there may be less strain on the vehicle engine during driving, allowing it to possibly increase fuel mileage and reduce oil and gas consumption. Additionally, the energy storage may be charged from charging stations or strategic charging such as during reduced engine shaft demand. Conversion kits can be manufactured to replace the old outdated electro magnet engagement clutch. These kits can be made for any and all conventional compressors. The DC power source and electric motor may be encased in a square vented box that can be bolted using three or four bolts to the existing A/C compressor. The system can be placed under the hood and bolted under the dashboard against the firewall. The exact specifications of this system may vary upon manufacturing.

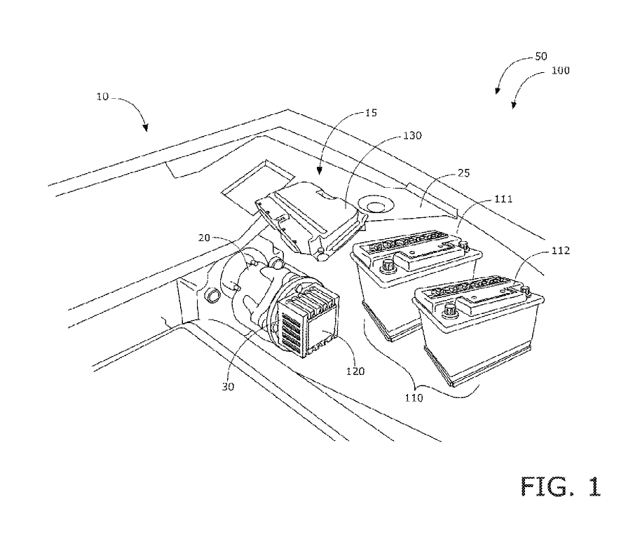

Referring now more specifically to the drawings by numerals of reference, there is shown in FIGS. 1-4, various views of a compressor drive system 100.

FIG. 1 shows a compressor drive system 100 during an ‘in-use’ condition 50, according to an embodiment of the present disclosure. Here, the compressor drive system 100 for a vehicle 10 is shown. The vehicle 10 includes a vehicle chassis 25 and an air-conditioner 15 having a compressor 20 with a drive clutch 30. Beneficially, use of the compressor drive system 100 may improve the efficiency of the vehicle's air-conditioning system while reducing horsepower loss and increasing gas mileage. As illustrated, the compressor drive system 100 may include a power supply 110 fixed to the vehicle 10, an electric motor 120 electrically coupled to the power supply 110, and mechanically coupled to the compressor 20. The electric motor 120 may be configured to drive the compressor 20. The compressor drive system 100 may further include a controller 130 communicably coupled to the vehicle 10, and configured to operate the electric motor 120 when the compressor drive system 100 is turned on, for example from vehicle A/C controls.

According to one embodiment, the power supply 110 may include a vehicle battery 111 of the vehicle 10. According to another embodiment, the compressor drive system 100 may further include an auxiliary battery 112 fixed to the vehicle 10 and independent of the vehicle battery 111. According to yet another embodiment, the power supply 110 may include both the auxiliary battery 112 and the vehicle battery 111. It is understood that the auxiliary battery 112 may include one or more batteries. According to one embodiment, at least one of the vehicle battery 111 and the auxiliary battery 112 may be a lithium ion battery.

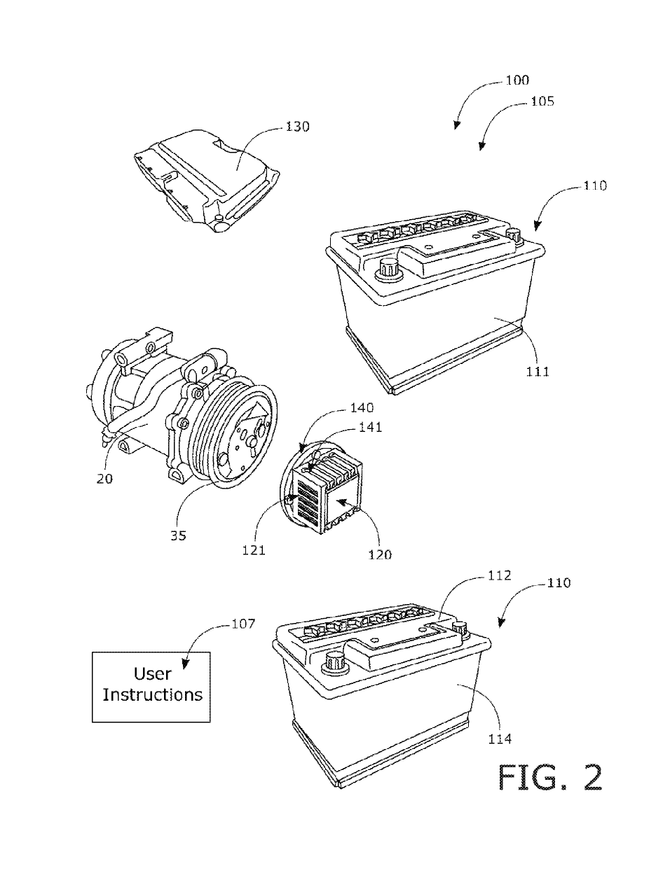

FIG. 2 shows the compressor drive system 100 of FIG. 1, according to an embodiment of the present disclosure. As above, the compressor drive system 100 may include the power supply 110, the electric motor 120, and the controller 130. As above, the power supply 110 may include the vehicle battery. Likewise, the power supply 110 of the compressor drive system 100 may further include the auxiliary battery 112.

According to one embodiment, the electric motor 120 may further include a heat exchanger 121 configured to cool the electric motor 120. For example, the heat exchanger 121 may be embodied as a passive cooling device, such as a finned radiator. Alternately, the heat exchanger 121 may be embodied as an active cooling device, such as a liquid cooled radiator, which may be plumbed with a vehicle cooling system. Other variations are contemplated.

According to one embodiment, the compressor drive system 100 may be arranged as a kit 105 for retrofitting an air-conditioner 15 (FIG. 1) in a vehicle 10 (FIG. 1).The kit 105 may include the power supply 110, a compressor adapter 140 configured to mount to the compressor 20, the compressor adapter 140 including an electric motor mount 141, an electric motor 120, and a controller 130. The compressor adapter 140 may be configured to provide a ground against which rotational force may be transferred to the compressor 20 as a direct drive. Further, as it is understood, each model of vehicle is unique, the compressor adapter 140 may be customized to anchor against or otherwise couple with the vehicle 10 (e.g., chassis 25) being retrofitted.

In addition, the compressor drive system 100 may further include a set of instructions 107. The instructions may detail functional relationships in relation to the structure of the compressor drive system 100, such that the compressor drive system 100 can be used, maintained, or the like, in a preferred manner.

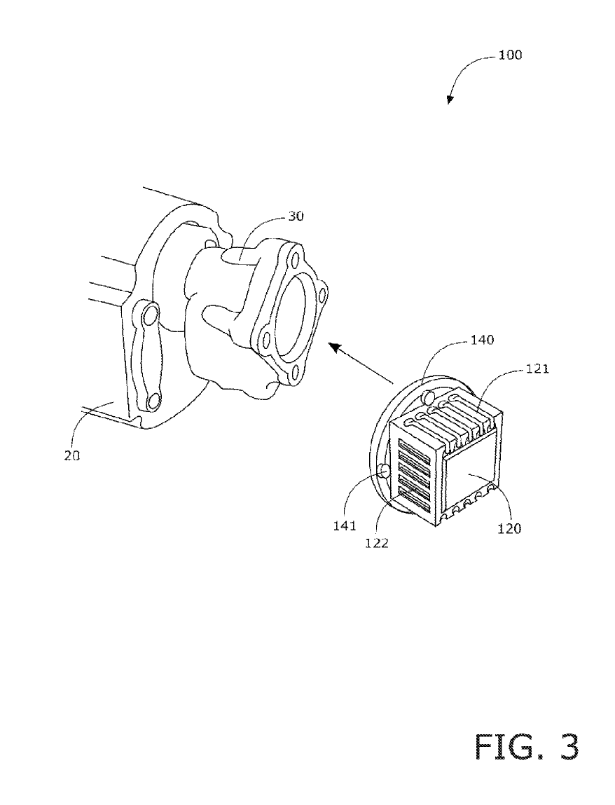

FIG. 3 is an assembly view of the compressor drive system 100 of FIG. 1, according to an embodiment of the present disclosure. This embodiment may include a compressor 20 having a drive clutch 30 configured to drivingly decouple the electric motor 120 from the compressor 20. As illustrated, the electric motor 120 including the heat exchanger 121 (embodied as a finned radiator) may be mounted to the compressor 20 by means of the compressor adapter 140, the compressor adapter 140 including an electric motor mount 141.

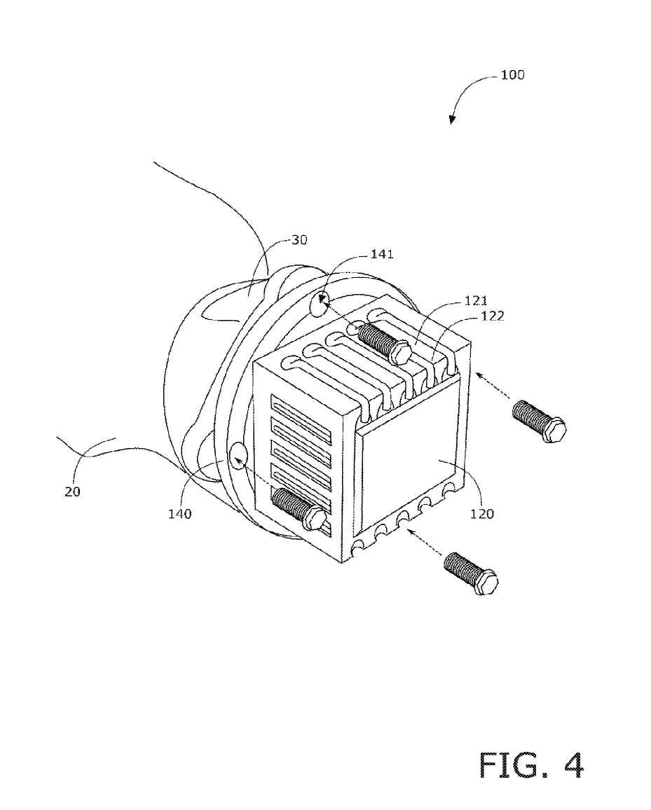

FIG. 4 is another assembly view of the compressor drive system 100 of FIG. 1, according to an embodiment of the present disclosure. This illustration shows the electric motor 120 configured to mechanically couple to the electric motor mount 141 of the compressor adapter 140. As above, the electric motor 120 is further configured to drive the compressor 20, and is customized to the particular vehicle of application. As above, the electric motor 120 may include the heat exchanger 121 with the finned radiator feature.

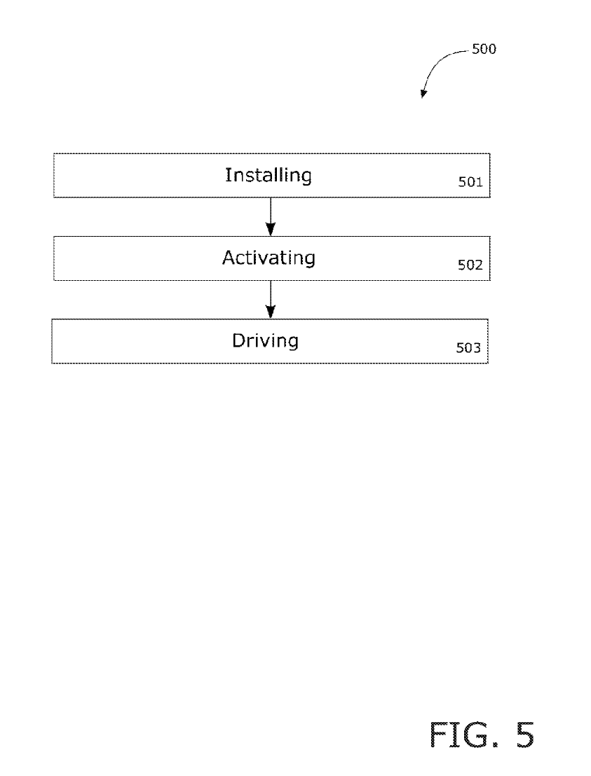

FIG. 5 is a flow diagram illustrating a method 500 of operating an air-conditioner 15 of a vehicle 10, according to an embodiment of the present disclosure. In particular, the method 500 may include one or more components or features of the compressor drive system 100 as described above. As illustrated, the method 500 may include the steps of: step one 501, installing the compressor drive system 100 in the vehicle 10, the compressor drive system 100 including a power supply 110 fixed to the vehicle 10, an electric motor 120 electrically coupled to the power supply 110 and mechanically coupled to the compressor 20, the electric motor 120 configured to drive the compressor 20, and a controller 130 communicably coupled to the vehicle 10, the controller 130 configured to operate the electric motor 120 when the compressor drive system 100 is turned on; step two 502, activating the air compressor 20 of the vehicle 10 while the engine is in an off state; step three 503, driving the compressor 20 of the air-conditioner 15 via the compressor drive system 100.

It should be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for a compressor drive system 100, are taught herein.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A compressor drive system for a vehicle, the vehicle including an air-conditioner having a compressor, the compressor drive system comprising:
a power supply fixed to the vehicle;
an electric motor electrically coupled to the power supply and mechanically coupled to the compressor, the electric motor configured to drive the compressor; and
a controller communicably coupled to the vehicle, and configured to operate the electric motor when the compressor drive system is turned on.

2. The compressor drive system of claim 1, wherein the power supply fixed to the vehicle is a vehicle battery.

3. The compressor drive system of claim 2, further comprising a heat exchanger, said heat exchanger configure to cool the electric motor; and
wherein the power supply fixed to the vehicle is a vehicle battery;
wherein the vehicle includes a vehicle chassis;
wherein the compressor and the electric motor are mounted to the vehicle chassis;
wherein the compressor includes a drive clutch configured to drivingly decouple the electric motor from the compressor; and
wherein the heat exchanger includes a finned radiator.

4. The compressor drive system of claim 1, wherein the power supply fixed to the vehicle is an auxiliary battery, the auxiliary battery being independent from a vehicle battery of the vehicle.

5. The compressor drive system of claim 4, wherein the auxiliary battery is selectably electrically coupled to the vehicle battery.

6. The compressor drive system of claim 4, wherein the auxiliary battery is a lithium ion battery.

7. The compressor drive system of claim 1, wherein the vehicle includes a vehicle chassis; and,
wherein the compressor and the electric motor are mounted to the vehicle chassis.

8. The compressor drive system of claim 1, wherein the compressor includes a drive clutch configured to drivingly decouple the electric motor from the compressor.

9. The compressor drive system of claim 1, further comprising a heat exchanger, said heat exchanger configure to cool the electric motor.

10. The compressor drive system of claim 9, wherein the heat exchanger includes a finned radiator.

11. A kit for retrofitting an air-conditioner in a vehicle, the air-conditioner including a compressor having a fan clutch, the kit comprising:
a power supply configured to affix to the vehicle;
a compressor adapter configured to mount to the compressor, the compressor adapter including an electric motor mount;
an electric motor configured to electrically couple to the power supply and to mechanically couple to the electric motor mount of the compressor adapter, the electric motor further configured to drive the compressor; and
a controller communicably coupled to the vehicle, and configured to operate the electric motor when the fan clutch of the compressor is engaged.

12. The kit of claim 11, wherein the power supply configured to affix to the vehicle is a vehicle battery.

13. The kit of claim 11, wherein the power supply configured to affix to the vehicle is an auxiliary battery, the auxiliary battery being separate from the vehicle battery of the vehicle.

14. The kit of claim 13, wherein the auxiliary battery is selectably electrically coupled to the vehicle.

15. The kit of claim 13, wherein the auxiliary battery is a lithium ion battery.

16. The kit of claim 11, wherein the vehicle includes a vehicle chassis; and,
wherein the electric motor mount is configured to bolt to the chassis.

17. The kit of claim 11, wherein the vehicle includes an engine configured to power the vehicle; and
wherein the electric motor is configured to operate independently from the engine of the vehicle.

18. The kit of claim 11, wherein the electric motor includes a heat exchanger, said heat exchanger configure to cool the electric motor.

19. The kit of claim 18, wherein the heat exchanger includes a finned radiator.

20. A method of operating an air conditioner of a vehicle, the air conditioner having a compressor, the vehicle including an engine configured to power the vehicle, the method comprising the steps of:
installing a compressor drive system in the vehicle, the compressor drive system including a power supply fixed to the vehicle, an electric motor electrically coupled to the power supply and mechanically coupled to the compressor, the electric motor configured to drive the compressor, and a controller communicably coupled to the vehicle, the controller configured to operate the electric motor when the compressor drive system is turned on;
activating the air compressor of the vehicle while the engine is in an off state; and
driving the compressor of the air conditioner via the compressor drive system.
